(19) United States
(12) Patent Application Publication
(10) Pub. No.: US 2025/0313487 A1
(43) Pub. Date: Oct. 9, 2025

(54) SOLUTION DEPOSITION OF METAL SALTS TO FORM METAL OXIDES

(71) Applicant: Oregon State University, Corvallis, OR (US)

(72) Inventors: Cory K. Perkins, Corvallis, OR (US); Douglas A. Keszler, Corvallis, OR (US)

(73) Assignee: Oregon State University, Corvallis, OR (US)

(21) Appl. No.: 19/049,891

(22) Filed: Feb. 10, 2025

Related U.S. Application Data
(63) Continuation of application No. 18/464,678, filed on Sep. 11, 2023, now abandoned.
Application No. 18/464,678 is a continuation of application No. 16/903,710, filed on Jun. 17, 2020, now abandoned.
(60) Provisional application No. 62/862,409, filed on Jun. 17, 2019.
(60) Provisional application No. 62/862,466, filed on Jun. 17, 2019.
(60) Provisional application No. 62/884,495, filed on Aug. 8, 2019.

(51) Int. Cl. C01G 19/02; C01G 30/00; C23C 18/12

(52) U.S. Cl. CPC C01G 19/02; C01G 30/007; C23C 18/1216

(57) ABSTRACT

Certain disclosed embodiments concern an organic solution suitable for forming metal oxide films, particularly thins films, comprising a metal salt selected from a Sn salt, an Sb salt, a dopant, and combinations thereof. The salt often is a halide salt, such as SnCl₂ or SbCl₃. Certain disclosed compositions are preferably formed using substantially pure reagents and may include a dopant, such as a fluoride dopant. Described solutions may be used to form thin films, such as a thin film comprising SnO₂, Sb:SnO₂, F:SnO₂, or (Sb,F):SnO₂. Such thin films may have any desired thickness, such as a thickness of from 200 or 700 nm, and are extremely smooth, such as having an RMS surface roughness>3 nm, such as 3 nm to 10 nm, with certain embodiments having an RMS surface roughness<2 nm or <1 nm. Devices can be assembled comprising the thin films on a suitable substrate.

### CROSS REFERENCE TO RELATED APPLICATIONS

This application is a continuation of U.S. patent application Ser. No. 18/464,678, filed Sep. 11, 2023, which is a continuation of U.S. patent application Ser. No. 16/903,710, filed on Jun. 17, 2020, which claims the benefit under 35 U.S.C. § 119 (e) of the Jun. 17, 2019, earlier filing dates of U.S. Provisional Patent Application No. 62/862,409 and U.S. Provisional Application No. 62/862,466, and the Aug. 8, 2019 filing date of U.S. Provisional Patent Application No. 62/884,495. U.S. Provisional Patent Application Nos. 62/862,409, 62/862,466 and 62/884,495 are incorporated herein by reference in their entireties.

### ACKNOWLEDGMENT OF GOVERNMENT SUPPORT

This invention was made with government support under Grant No. CHE-1606982 awarded by the National Science Foundation. The government has certain rights in the invention.

### FIELD

The present invention concerns metal oxides, such as SnO₂ and Sb:SnO₂, a method for making such oxides using high-purity solution compositions comprising tin and antimony reagents, and a method for forming conductive films comprising SnO₂ and Sb:SnO₂.

### BACKGROUND

Many electronic devices require forming thin metal oxide layers on substrates. Metal oxide layer formation is often done by sputtering, but this process requires using expensive processing equipment. New, less expensive and versatile methods are needed to address the increasing demand for electronic devices. Processing, for example, transparent conductive metal oxides to produce films having high conductivity, high transparency, and reduced manufacturing costs produces demands for versatile materials and methods suitable to achieve required performance goals.

### SUMMARY

Certain disclosed embodiments concern a solution suitable for solution deposition of metal oxides, such as SnO₂, Sb:SnO₂, F:SnO₂, or (Sb,F):SnO₂, as films. Such solutions comprise a metal salt selected from a Sn salt, an Sb salt, a dopant, and combinations thereof. Certain disclosed embodiments concern compositions comprising an organic solvent, such as s a nitrile solvent, an ether solvent, or a combination thereof. Specific disclosed exemplary embodiments comprise acetonitrile, tetrahydrofuran, and more typically a combination thereof as the solvent. The salt often is a halide salt, such as SnCl₂ or SbCl₃. Certain disclosed compositions are preferably formed using substantially pure reagents, such as a salt having a purity greater than 99.9%, a purity greater than 99.99%, a purity greater than 99.995%, or a salt having a purity greater than 99.999%. Certain disclosed embodiments concern compositions comprising a fluoride dopant. Suitable exemplary fluoride dopants include, without limitation, HF, NH₄F, aliphatic ammonium fluorides, more particularly tetra-alkyl ammonium fluorides, such as (CH₃)₄NF, CF₃COOH, SnF₂, SnF₄, or any and all combinations thereof.

Described solutions may be used to form thin films, such as a thin film comprising SnO₂, Sb:SnO₂, F:SnO₂, or (Sb,F):SnO₂. Such thin films may have variable thicknesses, depending on processing parameters, such as thicknesses greater than 0 nanometers up to at least 1 μm, such as 10 nm to 1,000 nm. Certain embodiments concern thin films having a thickness greater than or equal to 300 nm and an exceptional RMS surface roughness greater than 0 nm, typically 3 nm or greater, and typically less than 10 nm, such as 3 nm to 5 nm. Products having films made according to the present invention using reagents having a purity of 98% or greater typically exhibit resistivity values between 3.2-3.6×10⁻³ ohms·cm.

The present invention also provides a method for making thin films comprising preparing a solution comprising a metal salt selected from a Sn salt, an Sb salt, a dopant, and combinations thereof. The solution is then applied to a substrate to form a film. The film may then be annealed at a suitable annealing temperature. The method may further comprise assembling a device comprising such thin films on a suitable substrate.

The foregoing and other objects, features, and advantages of the invention will become more apparent from the following detailed description, which proceeds with reference to the accompanying figures.

### BRIEF DESCRIPTION OF THE DRAWINGS

FIG. 1 is a thickness (nm) versus concentration (M) curve.

FIG. 2 is a schematic drawing of an organic light emitting diode (OLED).

FIG. 3 is a schematic drawing of a solar device.

FIG. 4 is a graph of resistivity versus antimony atomic percent (Sb at. %) for various Sb:SnO₂ thin films according to the present disclosure annealed at 700° C.

FIG. 5 provides X-ray diffraction patterns [Intensity (a.u.)] of F:SnO₂ as a function of processing temperature (° C.) where all reflections match the cassiterite (SnO₂) phase, establishing that films made according to the present disclosure are crystalline after a 700° C. heating step.

### DETAILED DESCRIPTION

### I. Terms

The following explanations of terms and abbreviations are provided to better describe the present technology and to guide those of ordinary skill in the art to practice disclosed embodiments.

As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood by a person of ordinary skill in the art to which this disclosure pertains. Although methods and materials similar or equivalent to those described herein can be used to practice or test the present disclosure, suitable methods and materials are described below. The materials, methods, and examples are illustrative only and are not limiting. Other features of the disclosure are apparent from the detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

Aliphatic: A substantially hydrocarbon-based compound, or a radical thereof (e.g., C₆H₁₃, for a hexane radical), including alkanes, alkenes, alkynes, including cyclic versions thereof, and further including straight-and branched-chain arrangements, and all stereo and position isomers as well. Unless expressly stated otherwise, an aliphatic group contains from one to twenty-five carbon atoms; for example, from one to fifteen, from one to ten, from one to six, or from one to four carbon atoms. The term “lower aliphatic” refers to an aliphatic group containing from one to ten carbon atoms. An aliphatic chain may be substituted or unsubstituted. Unless expressly referred to as an “unsubstituted aliphatic,” an aliphatic group can either be unsubstituted or substituted. An aliphatic group can be substituted with one or more substituents (up to two substituents for each methylene carbon in an aliphatic chain, or up to one substituent for each carbon of a —C═C— double bond in an aliphatic chain, or up to one substituent for a carbon of a terminal methine group). Exemplary substituents include, but are not limited to, alkyl, alkenyl, alkynyl, alkoxy, alkylamino, alkylthio, acyl, aldehyde, amide, amino, aminoalkyl, aryl, arylalkyl, carboxyl, cyano, cycloalkyl, dialkylamino, halo, haloaliphatic, heteroaliphatic, heteroaryl, heterocycloaliphatic, hydroxyl, oxo, sulfonamide, sulfhydryl, thioalkoxy, nitro, or other functionality.

Alkyl: A hydrocarbon group having a saturated carbon chain. The chain may be cyclic, branched or unbranched. Examples, without limitation, of alkyl groups include methyl, ethyl, propyl, butyl, pentyl, hexyl, heptyl, octyl, nonyl and decyl. The term lower alkyl means the chain includes 1-10 carbon atoms. The terms alkenyl and alkynyl refer to hydrocarbon groups having carbon chains containing one or more double or triple bonds, respectively.

Roughness Average, Ra, is the arithmetic average of the absolute values of the profile heights over an evaluation length or area.

RMS Roughness is the root mean square average of film heights over an evaluation length or area. A thin film made by the disclosed method typically has a substantially smooth surface, such as a surface having an RMS roughness value of greater than zero nm, such as greater than 3 nm, including from 3 nm to less than 10 nm, 3 nm to less than 5 nm, from greater than zero nm to 2 nm or less, from greater than zero nm to 0.75 nm, from 0.1 nm to 0.7 nm, from 0.2 nm to 0.6 nm, from 0.3 nm to 0.6 nm, from 0.4 nm to 0.6 nm, or from 0.4 nm to 0.5 nm. RMS roughness values may be determined using atomic force microscope (AFM) measurements acquired over a selected area, such as a 1×1 μm² area.

Thin, as used herein with respect to a thin film or thin layer, refers to a film or layer typically having a film thickness or layer thickness of from greater than zero nm to 2 μm (2,000 nm), such as from greater than zero nm to 1 μm (1,000 nm), such as 200 nm to 700 nm, including 400 nm to 600 nm.

### II. Description

### A. Compositions, Precursor Reagents and Precursor Reagent Compositions Used to Make Compositions, and Films Comprising the Compositions

Disclosed embodiments concern tin oxide (SnO₂) compositions, antimony: tin oxide (Sb:SnO₂) compositions, doped tin oxide or a doped antimony: tin oxide compositions, and precursor reagents and compositions used to make such compositions. The present invention also concerns embodiments of a method for making films, particularly thin films, from solutions comprising SnO₂, Sb:SnO₂, doped SnO₂, and doped Sb:SnO₂. Particular embodiments concern doped conductive SnO₂ films or doped Sb:SnO₂ films that are useful for electronic applications, including halide-doped compositions and films, particularly fluoride-doped, tin oxide (F:SnO₂) and fluoride-doped, antimony tin oxide (Sb:F:SnO₂) compositions and films.

For Sb:SnO₂ films, the Sb: Sn amount may vary, as will be understood by a person of ordinary skill in the art. For example, disclosed embodiments range from greater than 0% Sb to about 25% Sb. A particular ratio of Sb: Sn is best determined by considering the desired physical properties in final products made therefrom, such as films for electronic applications.

Suitable SnO₂ precursors include any precursor that can be used to produce a desired tin oxide thin film. For particular disclosed embodiments, organic-solvent-soluble precursors are preferred. The soluble tin oxide precursor may be, for example, a tin complex or salt. In some embodiments, the tin compound is a tin halide, such as tin fluoride, tin chloride, tin bromide, or tin iodide; tin chlorohydrate; tin nitrate; tin nitrohydrate; tin acetate; tin sulfate; or any combination thereof. The amount of tin oxide precursor used is selected to produce a concentration of Sn²⁺ in solution suitable to facilitate production of a thin film with desired properties, such as a desired density, a desired thickness, a desired refractive index, and/or an RMS surface roughness. In some embodiments, the amount of tin oxide precursor is selected to produce a Sn²⁺ concentration in the solution of from greater than zero to 1 M or more, such as from 0.1 M to 0.9 M, from 0.2 M to 0.8 M or from 0.4 M to 0.8 M.

Suitable antimony precursors include any precursor that can be used to produce desired Sb:SnO₂ compositions and thin films resulting therefrom. Again, organic solvent soluble precursors are particularly suitable. The soluble Sb precursor may be an antimony complex or salt. In some embodiments, the antimony compound is an antimony halide, such as antimony fluoride, antimony chloride, antimony bromide, antimony iodide, or combinations of such halides; antimony chloride hydrate; antimony nitrate; antimony nitrate hydrate; antimony acetate; antimony sulfate; or any combination thereof.

Disclosed SnO₂ and Sb:SnO₂ compositions and films made therefrom may include a dopant to improve film properties, and/or electrical properties of the film. For certain disclosed embodiments, SnO₂ and Sb:SnO₂ precursor compositions include a doping reagent selected to impart a fluoride dopant to resultant SnO₂ and Sb:Sn₂O compositions. The fluoride dopant often is present in amounts difficult, and potentially impossible, to identify and quantify by known analytical methods. Instead, presence of the dopant in SnO₂ and Sb:SnO₂ compositions has been confirmed by considering electrical properties of SnO₂ and Sb:SnO₂ compositions made according to the present invention. That is, electrical properties of products made according to the present invention are improved, and perhaps are substantially improved, relative to products made that do not include dopants, such as fluoride dopants. Accordingly, the presence of dopant can be determined by first making a product that does not include a dopant, making at least a second product that does include a dopant, measuring electrical properties of the two products and comparing such properties. Dopants improve such measured products by some percentage amount, such as greater than 0% to at least 100%, or 2× or 3×. Fluoride dopants include, but are not limited to, HF or fluoride salts, such as ammonium fluoride, or fluorinated hydrocarbons with substituents such as CF₃COOH.

Data obtained for embodiments of the present application establish that the electrical properties of SnO₂ and Sb:SnO₂ films, including doped composition films, are substantially affected by even trace contaminants. Accordingly, certain disclosed embodiments concern using highly pure reagents, including reagents having a purity of at least 98%, such as 99%, 99.5%, 99.9%, 99.99%, 99.995 and 99.999%. Exemplary disclosed embodiments used reagents such as SbCl₃ (99.9%, Alfa-Aesar), SnCl₂ (99.999%, Beantown Chemical) and HF as a fluoride source (Ricca Chemicals, 99.99%).

The method for making SnO₂ and Sb:SnO₂ compositions generally comprises forming a suspension, or more likely dissolving a suitable precursor or precursors in a solvent, including compositions comprising multiple different solvents, to make a solution. Solvents used for the present invention typically are organic solvents selected by considering certain processing requirements, including reagent solubilities and ability to form Lewis adducts with metals, which facilitates metal solubility and forming compositions for solvent deposition.

Exemplary suitable organic solvents include, without limitation, ethers, thioethers azacycloalkanes, and nitriles. The ether may be: an aliphatic ether, such as an alkyl ether, including by way of example, dimethyl ether, methyl ethyl ether, and diethyl ether; or a cyclic aliphatic ether, such as oxacyclopentane (also known as tetrahydrofuran—THF) and oxacyclohexane (also known as tetrahydropyran—THP). Sulfur and nitrogen analogs of such ethers also may be suitable, including azacyclopentane (pyrrolidine), azacyclohexane (piperidine), thiacyclopentane (tetrahydrothiophene) and thiacyclohexane. Suitable nitriles include aliphatic nitriles, such as C₁-C₁₀alkyl nitriles, with one suitable example being acetonitrile (CH₃CN).

Combinations of ethers and nitriles are commonly used to practice method embodiments according to the present invention. For example, certain embodiments used a solvent combination comprising THF and CH₃CN. Precursor reagents are typically fairly soluble in THF. Nitriles, such as CH₃CN, are believed to form a Lewis adduct with Sn²⁺, Sb³⁺, or both. Without being bound by a particular theory of operation, Lewis adduct formation is understood to facilitate metal solubility and uniform film formation.

The ether/nitrile amounts may be varied as will be understood by a person of ordinary skill in the art, but typical solvent v/v percentages are from greater than 0 to less than 100 percent ether and less than 100 percent nitrile to greater than 0 percent nitrile. A more typical ether/nitrile ratio is from 1:1 to 4:1. Preferred co-solvents typically comprise at least 20% ether, such as at least 30%, at least 40%, at least 50%, at least 60%, at least 70%, or at least 80%, ether. For one particular embodiment, the ratio of ether to nitrile was 30:70.

Agitation may be used to facilitate forming desired precursor compositions such as stirring, shaking, sonication, or a combination thereof. Additionally, or alternatively, a precursor/solvent mixture may be heated to aid solution formation. The mixture may be heated at a temperature suitable to facilitate forming a solution, such as from 25° C. to solvent reflux, typically 100° C. or more, such as from 30° C. to 100° C., from 50° C. to 90° C. or from 70° C. to 90° C. The heating and/or agitation proceeds for a suitable time period, such as a few minutes to 48 hours, from 1 hour or less to 48 hours or more, from 6 hours to 36 hours, from 12 hours to 30 hours or from 18 hours to 24 hours. In some embodiments, a precursor/solvent mixture is heated and/or agitated in a sealed container, for example, to reduce evaporation.

### B. Forming a Thin Film

SnO₂, Sb:SnO₂, doped SnO₂, and doped Sb:SnO₂ compositions are deposited onto substrates, thin films are formed to form film-coated substrates, and the film-coated substrates are then used to form devices, or components of devices, such as electronic devices. The substrate can be any substrate on which a thin film can be formed, such as a silicon, including silica (SiO₂); glass; a metal; a metal alloy; an optical crystal, including non-linear optical crystals; a laser crystal; ceramic substrates; and substrates comprising combinations of such materials. In some embodiments, the substrate is a silicon substrate, such as a silicon wafer. In other embodiments, the substrate is a hydrophobic or hydrophilic glass, such as a silicate glass, i.e. a glass comprising silicon dioxide.

The thin film may be deposited on the substrate by any suitable technique. Suitable techniques include, but are not limited to, spin-coating, spray coating, ink-jet printing, mist deposition, dye-slot coating, dip coating, doctor blade application and combinations thereof. Particular embodiments of the present invention used spin coating to form films on suitable substrates. Large scale commercial production may require using a different technique, such as using a roll coater or doctor blade application. For spin coating, a selected composition and amount thereof are droplet dropped onto a substrate surface, and then the surface is rotated at a suitable rotation speed to coat the substrate surface effectively within a suitable period of time to provide a suitable film thickness. Spin coating may, for example, be conducted at from about 500 rpm to about 6,000 rpm, such as from 1,000 rpm to 5,000 rpm, 2,000 rpm to 4,000 rpm, with 4,000 rpm being used to form certain disclosed exemplary embodiments. The processing period is typically only a matter of seconds but does depend on the rotating speed, with typical processing times being from about 1 to about 10 seconds, with certain working embodiments using spin processing parameters of 4,000 rpm for 4 seconds.

For certain disclosed embodiments, the thin film is a dense film, i.e. a substantially non-porous film. Dense or non-porous films typically are made without using a surfactant. A thin film made by the disclosed method typically has a substantially smooth surface, such as a surface having an RMS roughness value of greater than zero nm, such as greater than 3 nm, including from 3 nm to less than 10 nm, 3 nm to less than 5 nm, from greater than zero nm to 2 nm or less, from greater than zero nm to 0.75 nm, from 0.1 nm to 0.7 nm, from 0.2 nm to 0.6 nm, from 0.3 nm to 0.6 nm, from 0.4 nm to 0.6 nm, or from 0.4 nm to 0.5 nm. The RMS roughness value may be determined by AFM measurements acquired over a selected area, such as a 1×1 μm² area. Such smooth surfaces may be advantageous, for example, for enhancing desired film properties and/or providing an enhanced interface with a second film or layer that is deposited on top of the thin film.

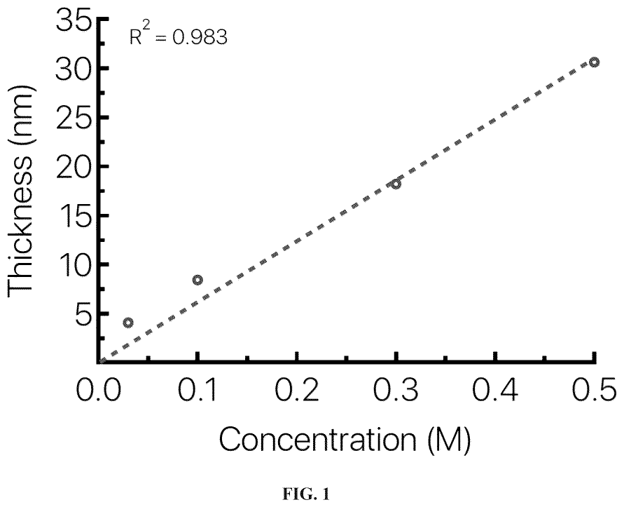

The thickness of the film after annealing can be selected, at least in part, by selecting the concentration of the precursor reagents. An exemplary concentration versus thickness curve is provided by FIG. 1. The equation to calculate thickness is t=(61.9c M⁻¹) nm, where c is the concentration of Sn in molarity. In some embodiments, film thicknesses can be directly selected for the preferred application by controlling processing parameters, such as amount deposited and/or application rate, reagent concentrations, etc.

### C. A Layered Film Comprising Multiple Thin Films

A layered film comprises multiple thin films, with at least one, some, or all of the films having compositions and/or physical properties of films as disclosed herein, with each thin film being a layer in the layered film. The layered film may comprise 2, 3, 4, 5, 6, 7, 8, 9, 10 or more layers. Sequential and/or non-sequential layers may have the same or different compositions, and/or physical properties and/or electrical properties, and/or optical properties. The layered film may comprise a composition change and/or gradient across the layers from the substrate to the surface layer. For example, there may be an increasing or decreasing amount of dopant in the layers from the substrate to the surface layer. In some embodiments, the different layers are selected to provide a change and/or gradient of desired properties. As used herein with respect to composition or a physical and/or optical property, a gradient across the layers refers to a change from a layer having a first composition and/or property to a second layer having a second composition and/or property where there are one or more intermediate layers, such as 2, 3, 4, 5, 6, 7, 8 or more intermediate layers, having intermediate compositions and/or properties that together with the first and second layers, form a gradual change from the first composition and/or property to the second composition and/or property. In some embodiments, the layered film comprises multiple compositional and/or property changes and/or gradients across the layers from the substrate to the surface.

A layered film may be made by depositing a first layer on a substrate and heating this layer at a first temperature below an annealing temperature for a time suitable to form a non-annealed layer, as described herein. A second layer can then be deposited on the surface of the first layer. The second layer may then be heated at a second temperature below an annealing temperature, the second temperature being the same or different than the first temperature. If the second layer is the desired outer or surface layer, heating at the second temperature optionally may be omitted. Additional layers can then be deposited by repeating the deposition and heating processes until all the desired layers have been deposited. Once the desired outer or surface layer is deposited, the layered film may be annealed at an annealing temperature. The outer or surface layer optionally may be heated at a temperature below the annealing temperature prior to annealing.

After deposition, the thin film optionally may be initially exposed to a temperature below the film's annealing temperature to, for example, evaporate some or substantially all of any residual solvent. This initial heating, or “soft baking,” may comprise exposing the film to a temperature of from 50° C. to 250° C., such as from 100° C. to 200° C., and may proceed for a time period of from greater than zero to the time required to achieve the desired result, such as from greater than zero to at least 5 minutes, or from 1 minute to 2 minutes. The film may be exposed to a first temperature for a first period of time, then exposed to a second temperature, typically higher than the first temperature, for a second period of time. In some embodiments, the film is exposed to a temperature of from 80° C. to 120° C. for a time period of from greater than zero to 3 minutes, such as from 1 to 2 minutes, then exposed at a temperature of from 150° C. to 250° C., such as from 180° C. to 220° C. for a time period of from greater than zero to 3 minutes, such as from 1 to 2 minutes.

A thin film may be heated in at least one heating step, such as exposed to a temperature suitable to anneal the film and produce a film having one or more desired properties, such as surface smoothness, film thickness and/or electrical or optical properties. The annealing temperature may be selected to ensure that substantially all of the residual components from the precursors, such as nitrates and any added processing aids, such as surfactants, are removed. The annealing temperature also may be conducted in an oxygen-containing environment to facilitate formation of metal oxides. Additionally, or alternatively, the annealing temperature may be selected to facilitate crystallization or substantially preclude film crystallization, as desired for the final product. Without being bound by a particular theory of operation, as the annealing temperature approaches the crystallization temperature of the film, the film may start to crystallize. To anneal, the film may be exposed to an annealing temperature of from 350° C. to 1,000° C. or more, such as from 400° C. to 1,000° C., from 450° C. to 900° C., from 450° C. to 800° C., from 450° C. to 700° C., from 450° C. to 600° C. or from 500° C. to 600° C., and in certain disclosed embodiments, the film was annealed by exposing the film to a temperature of about 600° C.-700° C. The film is exposed to the annealing temperature for a time period sufficient to sinter and anneal the film, as may be determined empirically. The time period may be from greater than one minute to 12 hours or more, such as from 5 minutes to 6 hours, from 15 minutes to 4 hours, from 30 minutes to 2 hours, or from 45 minutes to 90 minutes. In certain disclosed embodiments, the film was exposed to the annealing temperature for about 1 hour or less.

### III. Device Schematics

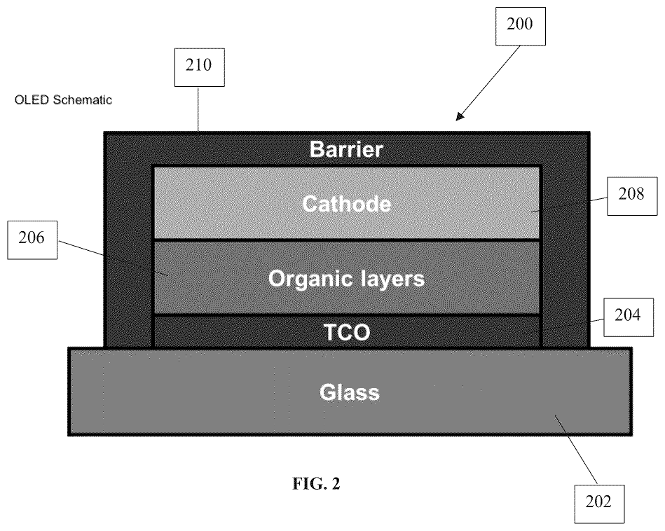

A person of ordinary skill in the art will appreciate that the products, such as thin films, made as disclosed herein can be used to make a number of useful devices. For example, such products can be used to form light emitting diodes, such as organic light emitting diodes. FIG. 2 provides a schematic drawing illustrating an exemplary OLED 200. OLED 200 comprises a substrate, such as a glass substrate 202. A thin film conductive oxide (TCO) layer 204 according to the present application is formed on the glass substrate 202. An organic layer 206 is then positioned adjacent to the TCO layer 204. OLED 200 also includes a cathode 208 and a barrier layer 210.

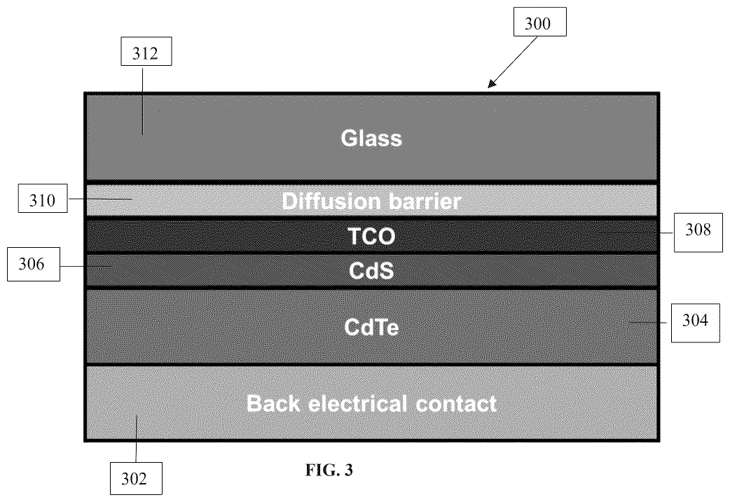

FIG. 3 illustrates an embodiment of a device 300 comprising a TCO according to the present application that is useful for solar applications. Device 300 includes a back electrical contact layer 302, a CdTe layer 304 and a CdS layer 306 positioned adjacent to CdTe layer 304. A TCO layer 308 according to the present application is positioned adjacent to the CdS layer 306. Device 300 also includes a diffusion barrier 310 and a glass substrate 312.

### IV. EXAMPLES

The following examples are provided to illustrate features of certain exemplary embodiments according to the present invention. A person of ordinary skill in the art will appreciate that the scope of the invention is not limited to these particular features.

### Example 1

### Precursor Formulation, Film Deposition, and Film Electrical Properties of Sb:SnO₂

SbCl₃ (99.9%, Alfa-Aesar) and SnCl₂ (99.999%, Beantown Chemical) were dissolved in tetrahydrofuran (THF), acetonitrile, or a combination of the two, in ratios between 0.01:1 and 0.2:1 of Sb/Sn. Solutions were droplet deposited on SiO₂ substrates and then thin films formed by spin coating at 4,000 RPM for 4 seconds. The deposited thin films were cured in air between 300° C. and 1000° C.

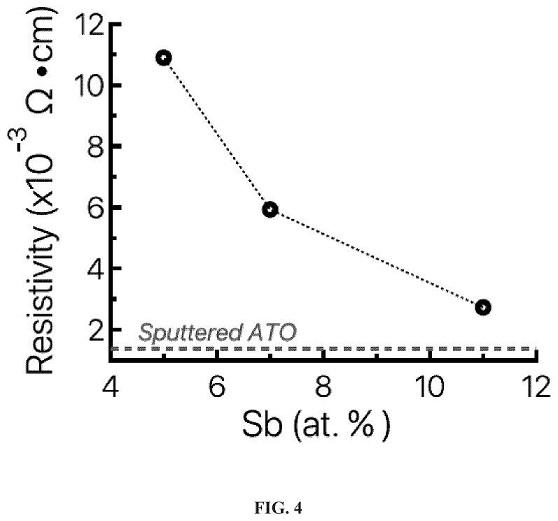

FIG. 4 provides the resistivity of films with selected Sb concentrations deposited from THF and cured at 700° C. for 1 hour. A resistivity value of ρ=2.5×10⁻³ ohm·cm occurs at an Sb concentration of 11 at %. In other conditions, resistivity values of ρ=1.3×10⁻³ ohm·cm have been observed which are the highest conductivity yet observed for a solution-processed Sb:SnO₂ (ATO) film.

Table 1 summarizes representative electrical properties for selected TCO thin films and provides information concerning resistivity (ρ), Hall mobility (μH), and carrier density (nH) for sputter deposited Sn-doped In₂O₃ (ITO), Al-doped ZnO (AZO), F-doped SnO₂ (FTO), Sb-doped SnO₂ (ATO), and Ta-doped SnO₂ (TTO) films. The values reported in Table 1 are best in class with respect to pH. FTO* and ATO* concern films produced according to the present disclosure. Vapor-deposited ATO films have resistivity values of about ρ=1.78×10⁻³ ohm·cm, which is only slightly lower than solution-processed films according to the present disclosure. The Hall mobility of solution-based films according to the present invention have values of about 27.5 cm² V⁻¹ s⁻¹, which substantially matches values for sputtered films of about 25 cm² V⁻¹ s⁻¹. The solution-deposited film referred to in Table 1 had a thickness of about 1.0 μm, and an RMS surface roughness of ≤1 nm, as determined by atomic force microscopy.

TABLE 1

| Material | ρ (10⁻⁴ Ω · cm) | μ_{H} (cm² V⁻¹ sec⁻¹) | n_{H} (10²⁰ cm⁻³) | Ref. |
|---|---|---|---|---|
| ITO | 1.3 | 32.7 | 14.6 | i |
| AZO | 1.4 | 67 | 5.5 | ii |
| FTO | 3.6 | 25 | 7 | iii |
| FTO* | 13 | | | |
| ATO | 17.8 | 25 | 3.4 | iv |
| ATO* | 13 | 27.5 | 1.8 | |
| TTO | 5.4 | 25.7 | 4.5 | iv |

i. Tuna, O.; Selamet, Y.; Aygun, G.; Ozyuzer, L. “High Quality ITO Thin Films Grown by DC and RF Sputtering without Oxygen.” J. Phys. D. Appl. Phys. 2010, 43, 55402.
ii. Minami, T.; Nanto, H.; Takata, S. ″Optical Properties of Aluminum Doped Zinc Oxide Thin Films Prepared by RF Magnetron Sputtering. Jpn. J. Appl. Phys. 1985, 24, L605.
iii. Geoffroy, C.; Campet, G.; Menil, F.; Portier, J.; Salardenne, J.; Couturier, G. “Optical and Electrical Properties of SnO2:F Thin Films Obtained by R. F. Sputtering With Various Targets.” Act. Passiv. Electron. Components 1991, 14, 111-118.
iv. Weidner, M.; Jia, J.; Shigesato, Y.; Klein, A. “Comparative Study of Sputter-Deposited SnO2 Films Doped with Antimony or Tantalum.” Phys. status solidi 2016, 253, 923-928.

### Example 2

### Solution Formulation, Film Deposition, and Film Properties of F:SnO₂.

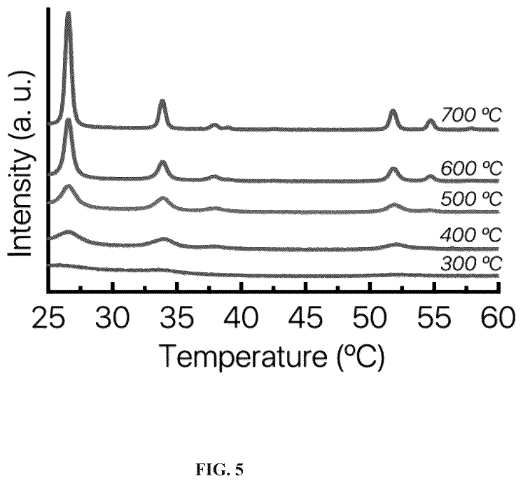

SnCl₂ is dissolved in tetrahydrofuran and HF as a fluorine source (Ricca Chemicals, 99.99% trace metals) is added. Solutions are deposited by spin coating SiO₂ at 4000 RPM for 4 seconds. F:SnO₂ (FTO) films annealed at 700° C. for 1 hour have resistivities≤1.3×10⁻³ ohm·cm and low RMS surface roughness=0.5 nm with thicknesses ranging from 300 nm to 1 μm. Films are crystalline after a 700° C. anneal (FIG. 5) and exhibit high electron mobilities (>17 cm² V⁻¹ sec⁻¹).

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A method for making a metal oxide thin film, comprising:
preparing an organic solution comprising a solvent; a metal salt selected from a Sn salt, an Sb salt, and combinations thereof; and a dopant;
spin-coating or die-slot coating the solution onto a substrate to form a film on the substrate, where the film has a thickness of greater than 200 nm to 700 nm and an RMS surface roughness of 2 nm or less measured over an area of at least 1×1 μm²; and
heating the film.

2. A device comprising a metal oxide thin film and a substrate, wherein the metal oxide thin film comprises SnO₂, Sb:SnO₂, F:SnO₂, or (Sb,F):SnO₂ and is made by a method comprising:
preparing a solution comprising (i) a metal salt, having a purity of at least 99.9%, the metal salt being selected from a Sn salt, an Sb salt, or combinations thereof, (ii) a fluoride dopant selected from HF, NH₄F, (CH₃)₄NF, CF₃COOH, SnF₂, SnF₄, and combinations thereof, and (iii) an organic solvent selected from an ether, a nitrile, or combinations thereof;
applying the solution to a substrate to form a film on the substrate having a thickness of 200 to 700 nm and an RMS surface roughness of 2 nm or less measured over at least 1×1 μm²; and
heating the film; and
wherein the film has
a resistivity of from 1×10⁻³-11×10⁻³ ohms·cm;
a Hall mobility of about 27.5 cm² V⁻¹ s⁻¹; or
a resistivity of from 1×10⁻³-11×10⁻³ ohms·cm and a Hall mobility of about 27.5 cm² V⁻¹ s⁻¹.
